(19) United States
(12) Patent Application Publication
(10) Pub. No.: US 2017/0203465 A1
(43) Pub. Date: Jul. 20, 2017

(54) ROUTER BIT

(71) Applicant: Phillip C. Crabtree, II, Owensboro, KY (US)

(72) Inventor: Phillip C. Crabtree, II, Owensboro, KY (US)

(21) Appl. No.: 15/000,314

(22) Filed: Jan. 19, 2016

(51) Int. Cl. B27G 13/12; B23C 5/10; B23C 3/28; B27G 13/00

(52) U.S. Cl. CPC B27G 13/12; B27G 13/002; B23C 5/10; B23C 3/28; B23C 2210/54; B23C 2220/36

(57) ABSTRACT

A router bit for use with a turning implement comprising a router bit body having a shank body adjacent a cutting body for forming a key hole in a work piece. The shank body has an outer surface configured to be received by the turning implement. The cutting body has a body portion that spans between a tapered head portion and a tapered end portion, the tapered end portion attached to the shank body. The tapered head portion has a plunge cutting surface that forms a first acute angle with the longitudinal axis. The shank body has a diameter that is smaller than the diameter of the tapered head portion. The tapered end portion has a diameter that varies along its length from the shank body to the tapered head portion to reduce breakage of the router bit body during use. A wing may be attached to the cutting body.

### BACKGROUND

The present invention relates generally to router or drill bits and, more particularly, to an improved router bit for use with a turning implement that is configured to form a ramped pocket in a work piece.

There are many types of router bits, drill bits, and end mills available for making various types of holes and openings in a work piece. Conventional drill bits typically only cut in an axial direction relative to the work piece. An end mill can generally cut in all directions. A flat bottom end mill can remove material inside a closed boundary on a flat surface of a work piece to a fixed depth and is typically used for pocket milling. In pocket milling, two steps are typically required to form the pocket: first, a bulk of material is removed in a roughing operation, and second, the pocket is finished by a finish end mill. Pocket milling with an end mill can be expensive and time consuming for a manufacturer. Center drill bits are often used to provide a starting hole for a larger-sized drill bit. Using a center drill bit to make an elongated slot is not practical and requires the use of a second drill bit which is time consuming for an operator to switch drill bits in a machine. Indexable drill bits are primarily used in computer numerical machines (“CNC machines”) and other high precision or production equipment and are the most expensive type of drill bit, costing more to manufacture per diameter and length as compared to other types of drill bits. Indexable drill bits use replaceable carbide or ceramic inserts as a cutting face. One insert is responsible for the outer radius of the cut, and another insert is responsible for the inner radius. The tool itself handles the point deformity. Almost all indexable drill bits have multiple coolant channels for prolonged tool life under heavy usage. They are capable of quite high axial loads and cut very fast. However, indexable drill bits are very expensive to manufacture and require replacement of the insert. Many of these drill bits and end mills require much time to manufacture a desired hole or pocket which equates to high production or manufacturing costs.

Thus, there is a need for improvement in this field.

### SUMMARY

Aspect 1 concerns a router bit for use with a turning implement, comprising a router bit body having a shank body adjacent a cutting body; the shank body having a longitudinal axis, the shank body having an outer surface configured to be received by the turning implement; and the cutting body attached to the shank body along the longitudinal axis, the cutting body having a tapered head portion opposite a tapered end portion and a body portion that spans between the tapered head portion and the tapered end portion, the tapered end portion attached to the shank body, wherein the tapered head portion has a substantially flat end surface opposite a rim and a plunge cutting surface that spans between the substantially flat end surface and the rim.

Aspect 2 concerns the router bit of aspect 1, wherein the plunge cutting surface forms an acute angle with the substantially flat end surface.

Aspect 3 concerns the router bit of aspect 2, wherein the acute angle is between about 3 degrees and 15 degrees.

Aspect 4 concerns the router bit of aspect 1, wherein the substantially flat end surface has a first diameter, the rim has a second diameter, wherein the first diameter is larger than the second diameter.

Aspect 5 concerns the router bit of aspect 4, wherein the body portion has a circular cross-sectional shape with a third diameter that is smaller than the second diameter of the rim.

Aspect 6 concerns the router bit of aspect 1, wherein the body portion has a length that spans along the longitudinal axis of between about 0.10 inches to about 0.25 inches.

Aspect 7 concerns the router bit of aspect 1, wherein the tapered end portion has a substantially circular cross-sectional shape with a diameter that increases along a length of the tapered end portion that extends from the body portion to the shank body.

Aspect 8 concerns the router bit of aspect 1, further comprising a wing attached to the cutting body, wherein the wing has a primary cutting edge that extends a distance away from the plunge cutting surface and a secondary cutting edge that extends a distance away from the body portion.

Aspect 9 concerns the router bit of aspect 1, further comprising a flute that extends from the tapered head portion to at least the tapered end portion.

Aspect 10 concerns a router bit for use with a turning implement, comprising a router bit body having a shank body adjacent a cutting body; the shank body having a longitudinal axis, the shank body having an outer surface configured to be received by the turning implement; and the cutting body attached to the shank body along the longitudinal axis, the cutting body having a tapered head portion opposite a tapered end portion and a body portion that spans between the tapered head portion and the tapered end portion, the tapered end portion attached to the shank body, wherein the tapered head portion has a plunge cutting surface that forms a first acute angle with the longitudinal axis.

Aspect 11 concerns the router bit of aspect 10, wherein the first acute angle is between about 3 degrees and 15 degrees.

Aspect 12 concerns the router bit of aspect 10, wherein the tapered head portion has a length of about 0.125 inches as measured along the longitudinal axis.

Aspect 13 concerns the router bit of aspect 10, further comprising a wing attached to the cutting body, wherein the wing has a primary cutting edge adjacent a secondary cutting edge, the primary cutting edge extends a distance away from the plunge cutting surface, and the secondary cutting edge extends a distance away from the body portion.

Aspect 14 concerns the router bit of aspect 13, wherein the primary cutting edge forms a second acute angle with the longitudinal axis.

Aspect 15 concerns the router bit of aspect 14, wherein the first acute angle is substantially the same as the second acute angle.

Aspect 16 concerns the router bit of aspect 13, wherein the wing includes an end surface that extends substantially perpendicular to the longitudinal axis.

Aspect 17 concerns the router bit of aspect 13, wherein the secondary cutting edge extends substantially parallel to the longitudinal axis.

Aspect 18 concerns the router bit of aspect 10, further comprising the shank body having a distal end opposite a proximal end wherein the proximal end is attached to the tapered head portion; and a flute that extends from the tapered head portion to at least the proximal end of the shank body.

Aspect 19 concerns the router bit of aspect 10, wherein the tapered head portion has a substantially flat end surface opposite a rim and the plunge cutting surface spans between the substantially flat end surface and the rim.

Aspect 20 concerns the router bit of aspect 19, wherein the substantially flat end surface has a first diameter and the rim has a second diameter, wherein the first diameter is larger than the second diameter.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a first plan view of an embodiment of a router bit according to the present disclosure.

FIG. 2 is a partial, enlarged detail of the FIG. 1 router bit.

FIG. 3 is a second plan view of the FIG. 1 router bit.

FIG. 4 is a partial, enlarged detail of the FIG. 3 router bit.

FIG. 5 is a third plan view of the FIG. 1 router bit.

FIG. 6 is a partial, enlarged detail of the FIG. 5 router bit.

FIG. 7 is a top plan view of the FIG. 1 router bit.

FIG. 8 is a bottom plan view of the FIG. 1 router bit.

FIG. 9 is a top perspective view of the FIG. 1 router bit.

FIG. 10 is a flow diagram of a method for using an embodiment of a router bit according to the present invention.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

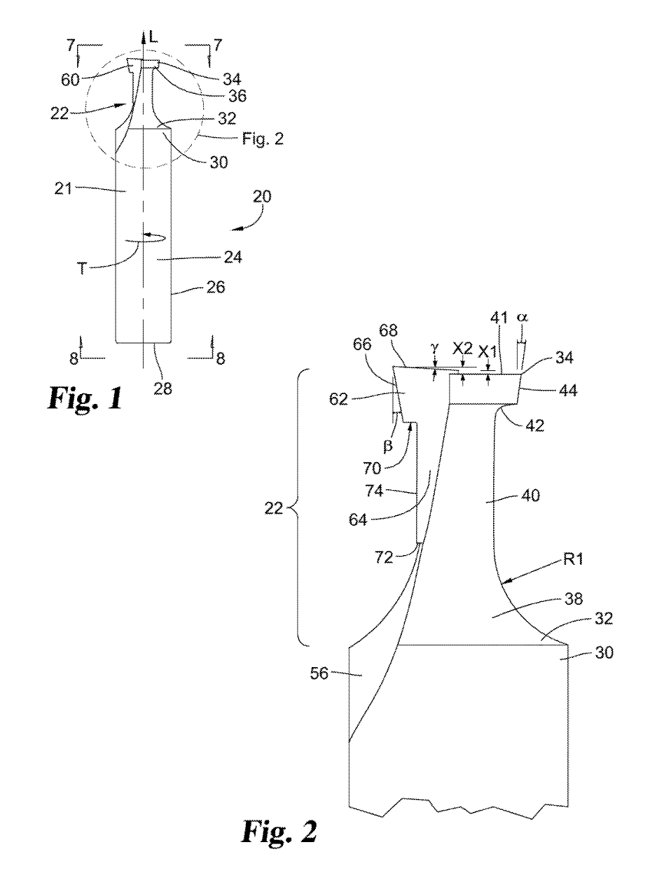

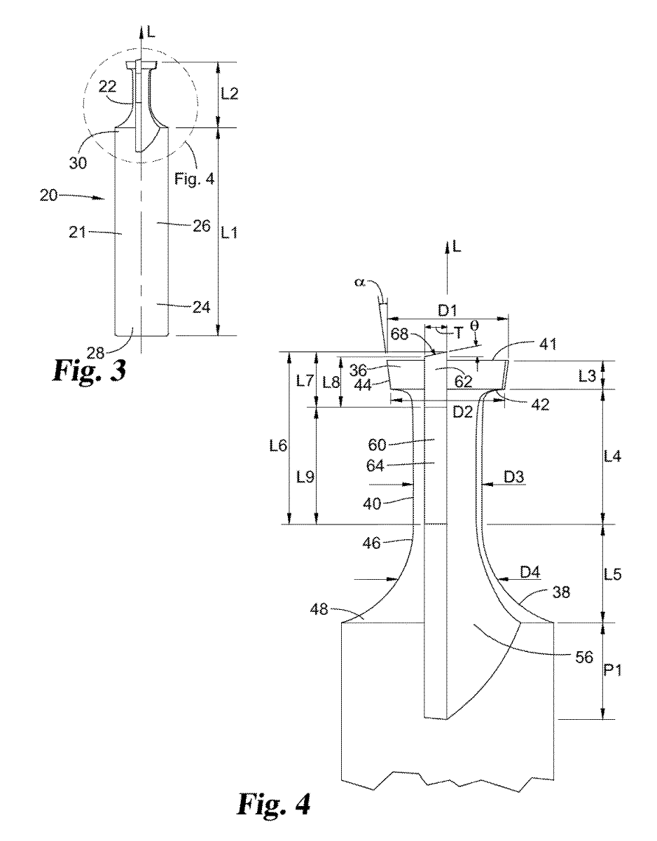

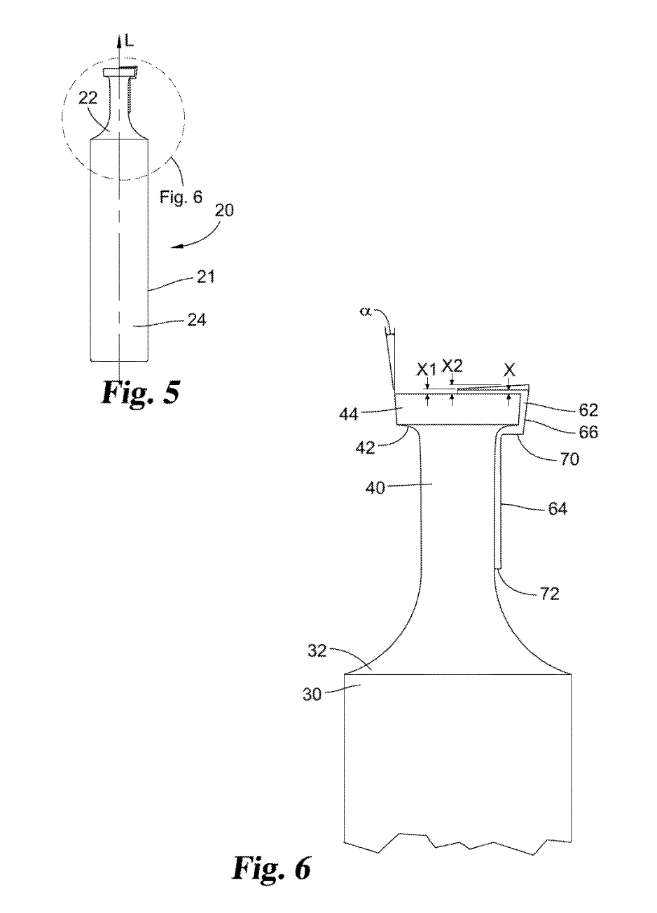

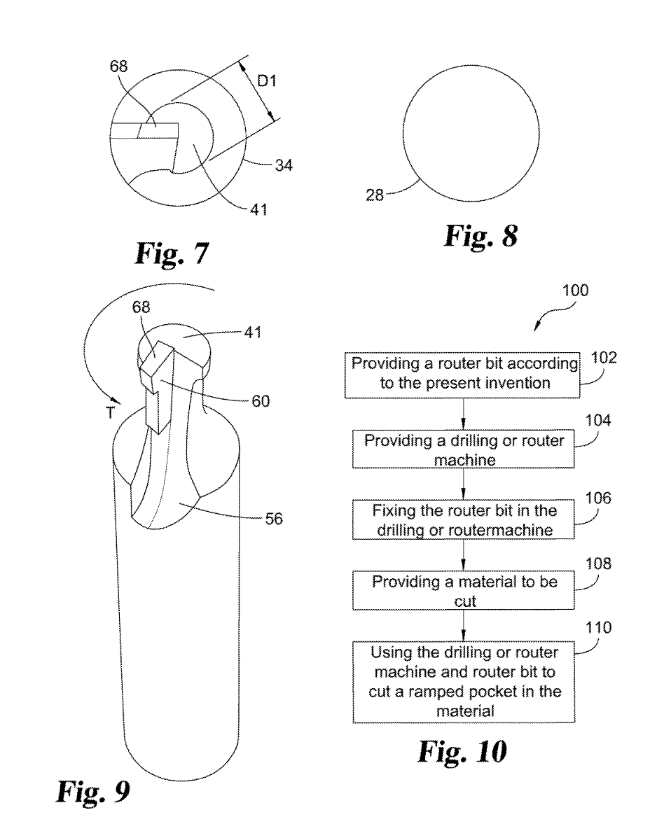

Referring to FIGS. 1-9, a router bit 20 for use with a turning implement or router machine is illustrated. The router bit 20 may be used with a turning implement to form a pocket or ramped pocket in a work piece. One example of a pocket formed in a work piece is illustrated as a key hole or an extended key hole as described in U.S. Publication No. 2015/0147113 A1, which is hereby incorporated by reference. The router bit 20 creates a pocket or key hole in a first work piece to receive the unique shape and tension requirements needed to receive the key mounted in a second work piece as described in U.S. Publication No. 2015/0147113 A1. The key hole or pocket formed by the router bit 20 creates the proper linking strength between the second work piece in which the key is mounted and the first work piece in which the pocket or key hole is formed. The router bit 20 includes a router bit body 21 having a cutting body 22 adjacent a shank body 24 with a central longitudinal axis L that spans along a length of each of the cutting body 22 and the shank body 24 of the router bit body 21.

The shank body 24 has a cylindrical shape with an outer surface 26 and a length L1 that together span from a proximal end 28 to a distal end 30. The outer surface 26 is configured to be received by the turning implement and in the illustrated embodiment the outer surface 26 is smooth. The outer surface 26 may vary in other embodiments such as including grooves, indentations, or other mechanisms for engagement with the turning implement. The shank body 24 has a diameter that may be between about 0.25 inches to about 1.5 inches and in one form is about 0.5 inches and a length L1 that may be between about 0.5 inches to about 4 inches and in one form is 2.0 inches.

The cutting body 22 is monolithic with the shank body 24 but may be attached to the shank body 24 in another form. The cutting body 22 has a length L2 that spans between a proximal end 32 opposite a distal end 34 wherein the proximal end 32 is adjacent to and attached to the distal end 30 of the shank body 24. The cutting body 22 has a tapered head portion 36 opposite a tapered end portion 38 and a body portion 40 that spans between the tapered head portion 36 and the tapered end portion 38.

The tapered head portion 36 has a substantially flat end surface 41 opposite a rim 42 and a plunge cutting surface 44 that spans between the substantially flat end surface 41 and the rim 42. The substantially flat end surface 41 is substantially circular in shape and has a first diameter D1. When the router bit 20 is used with a turning implement, the circular shape of the end surface 41 forms a circular opening or entry hole in the pocket such as a tab opening in the key hole as described in U.S. Publication No. 2015/0147113 A1. As the router bit 20 travels from the opening that is formed in the work piece along a length of the work piece in a horizontal direction relative to the work piece, the end surface 41 being substantially flat forms a flat bottom surface of the pocket or key hole. The flat bottom surface of the pocket or key hole in the work piece is perpendicular relative to an end surface of a dowel or key such that the end surface of the dowel or key rides along the flat bottom surface of the work piece when the key is assembled with the key hole or pocket. The end surface 41 is substantially flat to plunge into the work piece, and beneficially the end surface 41 does not wear down as compared to a pointed tip on a drill bit that would wear down much faster. The rim 42 is substantially circular in shape and has a second diameter D2. The tapered head portion 36 has a length L3 that spans between the flat end surface 41 and the rim 42 such that the rim 42 is offset a distance from the flat end surface 41 that corresponds to the length L3. The first diameter D1 of the flat end surface 41 is larger than the second diameter D2 of the rim 42 to create a larger entry hole or tab opening in a work piece for inserting a fastener or key into the pocket. The first diameter D1 may vary from 0.2 inches to about 1.0 inch and in one form is about 0.35 inches. The offset between the first diameter D1 of the end surface 41 and the second diameter D2 of the rim 42 and the length L3 of the tapered head portion 36 form a first acute angle α. The plunge cutting surface 44 is oriented as determined by the first acute angle α. The first acute angle α may be between about 3 degrees and 15 degrees and in one form is 9 degrees. The length L3 of the tapered head portion 36 may be about 0.125 inches as measured along the longitudinal axis L and may be between 0.010 inches to about 0.50 inches.

The body portion 40 has a circular cross-sectional shape with a third diameter D3 that is smaller than the second diameter D2 of the rim 42. The second diameter D2 may be about 0.255 inches and may range from about 0.125 inches to about 0.75 inches. The body portion 40 has a substantially smooth outer surface. The body portion 40 has a length L4 that spans along the longitudinal axis L between the tapered head portion 36 and the tapered end portion 38. The length L4 of the body portion 40 may be between about 0.10 inches to about 0.25 inches and in one form is 0.188 inches. Since the third diameter D3 is the smallest diameter of the cutting body 22, it is also vulnerable to more wear and breakage when the router bit 20 is used with a turning implement as compared to either the tapered head portion 36 or the tapered end portion 38. The length L4 of the body portion 40 is minimized to reduce breakage of the router bit 20 during use thereof and is critical in the life and the strength of the router bit 20. Because the body portion 40 has the smallest diameter as compared to the diameters of the tapered head portion 36 and the tapered end portion 38, it is important to keep length L4 as short as possible to avoid breakage of the router bit 20. If the length L4 is too long or the diameter D3 is too small, the body portion 40 will be too brittle and will break while attempting to create the pocket or the groove slot portion of the keyhole.

The tapered end portion 38 is attached to the distal end 30 of the shank body 24 and spans between the body portion 40 and the shank body 24. The tapered end portion 38 has a substantially circular cross-sectional shape with a diameter D4 that increases along a length L5 of the tapered end portion 38 as measured from the body portion 40 to the shank body 24. The tapered end portion 38 has a proximal region 46 that has the same diameter as the third diameter D3 of the body portion 40. The tapered end portion 38 has a distal region 48 that has the same diameter as the distal end 30 of the shank body 24. The distal region 48 is a substantially wider diameter than the proximal region 46 of the body portion 40.

The router bit body 21 has a recess or flute 56 that extends from the distal end 34 of the cutting body 22 to the distal end 30 of the shank body 24. Flute 56 is an arc shaped recess that extends from an outer surface 26 of the cutting body 22 towards the longitudinal axis L. In another form, the flute 56 may not extend fully to the longitudinal axis L from the outer surface of the cutting body 22. Flute 56 is configured for removing chips or curls from a work piece and/or allowing lubricants or coolants to reach the distal end 34 of the cutting body 22. Flute 56 supplants about ¼ or 25% of the cross-sectional area of the cutting body 22 and extends the full length of the cutting body 22 which includes lengths L3, L4, and L5 of the tapered head portion 36, the body portion 40, and the tapered end portion 38, respectively. Flute 56 also supplants about ¼ or 25% of the cross-sectional area of the distal end 30 of the shank body 24. In the illustrated embodiment, flute 56 extends a portion P1 of the length L1 of the shank body 24. Flute 56 may supplant more or less of the cross-sectional area of the distal end 30 of the shank body 24 and extend more or less than portion P1 of the length L1 of the shank body 24. Alternatively, flute 56 may not extend into the shank body 24 thereby eliminating portion P1 such that flute 56 stops at the tapered end portion 38.

The router bit body 21 has a wing 60 attached to the cutting body 22 along the flute 56. The wing 60 has a primary cutting portion 62 adjacent a secondary cutting portion 64. The wing 60 has a thickness T that is constant along a length L6 of the wing 60. The primary cutting portion 62 has a length L7 and a length L8 that span between an end surface 68 and a first lip 70. As such, the end surface 68 forms an angle θ relative to the end surface 41 as measured between length L7 and length L8. The angle θ can range from about 1 degree to about 30 degrees but can be larger or smaller in other embodiments. The length L7 and the length L8 of the primary cutting portion 62 are larger than the length L3 of the tapered head portion 36. The lengths L7 and L8 of the primary cutting portion 62 extend beyond the end surface 41 along the longitudinal axis L such that the primary cutting portion 62 will engage and contact a work piece before length L3 of the tapered head portion 36 would contact the work piece when the router bit 20 is positioned perpendicular to the work piece. The engagement of the lengths L7 and L8 of the primary cutting portion 62 enable the primary cutting portion 62 to cut into a work piece when the router bit 20 initially plunges into the work piece. Specifically, when the router bit 20 rotates and plunges into a work piece to create an opening, the longer lengths L7 and L8 of the primary cutting portion 62 initially cut into the work piece If the lengths L7 and L8 of the primary cutting portion 62 end at the tapered head portion 36 such that the end surface 41 and the end surface 68 are planar and flat relative to each other, then the primary cutting portion 62 would not cut or plunge easily and cleanly into the work piece. If the lengths L7 and L8 of the primary cutting portion 62 and length L3 of the tapered head portion 36 ended in the same plane, then the tapered head portion 36 and the wing 60 would be flush against the work piece. The lengths L7 and L8 of the primary cutting portion 62 are longer than the length L3 of the tapered head portion 36 to further enable the primary cutting portion 62 to cut into the work piece as the router bit 20 moves across the work piece. The primary cutting portion 62 has a primary cutting edge 66 that spans between the end surface 68 and the first lip 70 wherein the primary cutting edge 66 is positioned a distance away from or offset from the plunge cutting surface 44 as illustrated in FIG. 6. The primary cutting edge 66 forms a second acute angle β as measured relative to the longitudinal axis L. In one form, the second acute angle β is substantially the same as the first acute angle α. The second acute angle β may be between about 3 degrees and 15 degrees and in one form is 9 degrees. During use, the router bit 20 moves across the work piece to create the pocket, key hole, or other slot in the work piece, wherein the lengths L7 and L8 of the primary cutting portion 62 and the primary cutting edge 66 engage the work piece before the length L3 of the tapered head portion 36 engages the work piece. The primary cutting portion 62 has an end surface 68 that extends from the longitudinal axis L to the primary cutting edge 66 at an angle γ. The angle γ can range from about 1 degree to about 30 degrees. Alternatively, the end surface 68 may extend perpendicular relative to the longitudinal axis L. The end surface 68 is offset a distance X1 from the end surface 41 at or near the longitudinal axis L The end surface 68 is offset a distance X2 from the end surface 41 at the primary cutting edge 66. The angle γ is measured relative to the distances X1 and X2 and the end surface 68. The end surface 68 is offset a distance X (illustrated in FIG. 6) from the end surface 41 wherein the distance X spans from the longitudinal axis L to the primary cutting edge 66. The primary cutting portion 62 has a first lip 70 that may be perpendicular to the longitudinal axis L or extend at an angle relative to the longitudinal axis L. The end surface 68 has a longer length than the first lip 70.

The secondary cutting portion 64 has a secondary cutting edge 74 that spans between the first lip 70 and a second lip 72 and a length L9 that spans between the first lip 70 and the second lip 72. The length L9 of the secondary cutting edge 74 ends at the intersection of the body portion 40 and the tapered end portion 38. The secondary cutting edge 74 is positioned a distance away from or offset from the body portion 40. The secondary cutting edge 74 extends substantially parallel to the longitudinal axis L. Alternatively, the secondary cutting edge 74 may extend at an angle relative to the longitudinal axis L. The secondary cutting portion 64 has a second lip 72 that extends substantially perpendicular from the longitudinal axis L to the secondary cutting edge 74. The first lip 70 has a longer length than the second lip 72.

FIG. 10 is a flow diagram of an embodiment of a method 100 for using an embodiment of a router bit of the present invention. A router bit 20 of the present invention may be provided 102. A drilling machine or router machine may also be provided 104. A drilling machine or a router machine may include but not be limited to a hand drill motor, a drill press, a mill, a lathe, an NC mill (including a CNC mill), an NC lathe (including a CNC lathe), a router (including a CNC router) machine, a point to point machine, or any other machine that may be used to drill a hole. The router bit 20 may be fixed 106 in the drilling or router machine. This may include inserting the router bit 20 into the drilling machine and tightening a chuck or other mechanism for fixing a router bit in a drilling or router machine.

A material to be drilled may also be provided 108. The material may be a composite or may be any material through which a hole may be desirably drilled, such as wood, metal, masonry, etc.

The drilling machine and router bit 20 may be used 110 to drill or cut a keyhole or pocket in the provided material. This may include using a vacuum to hold the material against a spoil board or otherwise fixing the material in a vise or jig in order to prevent the material from moving while drilling or cutting. In the case of an NC machine, this may include programming the NC machine to drill or cut in desired locations. In the case of a hand drill motor, the user may hold the material in place by hand.

The drilling machine and router bit 20, in particular, the tapered head portion 36 and the wing 60 may be used to form the tab opening, the bottom surface of the key hole, and the end portion of the key hole as described in U.S. Publication No. 2015/0147113 A1. In particular, the first lip 70 and the primary cutting edge 66 of the primary cutting portion 62 create the ramp and the dowel seat of the key hole as described in U.S. Publication No. 2015/0147113 A1. The body portion 40 creates the groove slot portion of the key hole as described in U.S. Publication No. 2015/0147113 A1.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. A router bit for use with a turning implement, comprising:
a router bit body having a shank body adjacent a cutting body;
the shank body having a longitudinal axis, the shank body having an outer surface configured to be received by the turning implement; and
the cutting body attached to the shank body along the longitudinal axis, the cutting body having a tapered head portion opposite a tapered end portion and a body portion that spans between the tapered head portion and the tapered end portion, the tapered end portion attached to the shank body, wherein the tapered head portion has a substantially flat end surface opposite a rim and a plunge cutting surface that spans between the substantially flat end surface and the rim.

2. The router bit of claim 1, wherein the plunge cutting surface forms an acute angle with the substantially flat end surface.

3. The router bit of claim 2, wherein the acute angle is between about 3 degrees and 15 degrees.

4. The router bit of claim 1, wherein the substantially flat end surface has a first diameter, the rim has a second diameter, wherein the first diameter is larger than the second diameter.

5. The router bit of claim 4, wherein the body portion has a circular cross-sectional shape with a third diameter that is smaller than the second diameter of the rim.

6. The router bit of claim 1, wherein the body portion has a length that spans along the longitudinal axis of between about 0.10 inches to about 0.25 inches.

7. The router bit of claim 1, wherein the tapered end portion has a substantially circular cross-sectional shape with a diameter that increases along a length of the tapered end portion that extends from the body portion to the shank body.

8. The router bit of claim 1, further comprising:
a wing attached to the cutting body, wherein the wing has a primary cutting edge that extends a distance away from the plunge cutting surface and a secondary cutting edge that extends a distance away from the body portion.

9. The router bit of claim 1, further comprising:
a flute that extends from the tapered head portion to at least the tapered end portion.

10. A router bit for use with a turning implement, comprising:
a router bit body having a shank body adjacent a cutting body;
the shank body having a longitudinal axis, the shank body having an outer surface configured to be received by the turning implement; and
the cutting body attached to the shank body along the longitudinal axis, the cutting body having a tapered head portion opposite a tapered end portion and a body portion that spans between the tapered head portion and the tapered end portion, the tapered end portion attached to the shank body, wherein the tapered head portion has a plunge cutting surface that forms a first acute angle with the longitudinal axis.

11. The router bit of claim 10, wherein the first acute angle is between about 3 degrees and 15 degrees.

12. The router bit of claim 10, wherein the tapered head portion has a length of about 0.125 inches as measured along the longitudinal axis.

13. The router bit of claim 10, further comprising:
a wing attached to the cutting body, wherein the wing has a primary cutting edge adjacent a secondary cutting edge, the primary cutting edge extends a distance away from the plunge cutting surface, and the secondary cutting edge extends a distance away from the body portion.

14. The router bit of claim 13, wherein the primary cutting edge forms a second acute angle with the longitudinal axis.

15. The router bit of claim 14, wherein the first acute angle is substantially the same as the second acute angle.

16. The router bit of claim 13, wherein the wing includes an end surface that extends at an acute angle relative to the longitudinal axis.

17. The router bit of claim 13, wherein the secondary cutting edge extends substantially parallel to the longitudinal axis.

18. The router bit of claim 10, further comprising:
the shank body having a distal end opposite a proximal end wherein the proximal end is attached to the tapered head portion; and
a flute that extends from the tapered head portion to at least the proximal end of the shank body.

19. The router bit of claim 10, wherein the tapered head portion has a substantially flat end surface opposite a rim and the plunge cutting surface spans between the substantially flat end surface and the rim.

20. The router bit of claim 19, wherein the substantially flat end surface has a first diameter and the rim has a second diameter, wherein the first diameter is larger than the second diameter.
